(19) United States
(12) Patent Application Publication
(10) Pub. No.: US 2015/0231656 A1
(43) Pub. Date: Aug. 20, 2015

(54) PUMP SUCTION/EXPULSION FOR LIQUIDS AND GASES VERSATILE

(71) Applicant: Carlos Saravia Castillon, Durango (MX)

(72) Inventor: Carlos Saravia Castillon, Durango (MX)

(21) Appl. No.: 14/382,542

(22) PCT Filed: Apr. 2, 2012
(86) PCT No.: PCT/MX2012/000036

§ 371 Date: Apr. 21, 2015

(51) Int. Cl. B05B 11/00; F04B 39/12; F04B 35/01; F04B 41/02; F04B 39/08; F04B 9/04; F04B 23/02

(52) U.S. Cl. CPC B05B 11/30; F04B 9/042; F04B 39/12; F04B 23/02; F04B 41/02; F04B 39/08; F04B 35/01

(57) ABSTRACT

A pump for supplying liquids or gases, comprising: a mechanism of suction/discharge consists of a handle, fasteners and injection pump, a piston, a dispenser, a body of valves, two valves, pump a shirt, a piece containing a pumping chamber, at least two primary and secondary supports, bridge pump with at least two fastening means of conduit and oppressive cam piston articles attachments or pump and tank securing means; a container of liquid or gas should be projected by suction/expulsion; a hose transports.

### TECHNICAL FIELD OF THE INVENTION

The present invention relates to the technical field of the mechanical, more specifically in the area of hand pumps to deliver fluids or gases, providing a pump to supply water in manually, light painting, oil, fertilizer, insecticide, air for filling tires, balloons, etc.

### BACKGROUND OF THE INVENTION

One of the problems that have arisen in the area of hand pumps, is that there is a pump that is versatile, which can exert several activities either to inflator a ball, balloon, tire, to provide light liquids such as water to be used as a pump sprayer or misting up to provide heavy liquids such as paint, is the fact that the paint is thick, viscous and sticky, whose consistency is more like honey; and therefore when dried paste parts and obstructs ducts. Has an unstable chemical that constantly tend to create phlegm, cream and lumps. Although there has been properly filtered, can clog ducts at any time, either while painting, or especially, when left at rest; as insecticides or herbicides are lighter this pump can supply the amount needed to give effect misting or throwing the liquid jet, which is to be applied, that is why existing hand pumps on the market just do a function or at most two functions as throwing fluid or air jet or spray, but are limited to misting or heavy liquids or you need to have an electrical system to throw hard and liquid.

In order to eliminate all the aforementioned drawbacks, some novel improvements to a mechanism for throwing fluids or gases including means for supplying efficiently developed in addition to a major emphasis on versatility of uses and in the same washing is done. This invention allows the delivery of liquids or gases, with an easy and continuous flow, plus it has a fastening system objects in the same body that allows in some situations adhere or couple it, a roller and/or understandable handle with which through a hose supplying the liquid or gas and thus have better support, which I describe below.

### BRIEF DESCRIPTION OF THE DRAWINGS

FIG. 1 is a side view of the pump with the bridge of the pump and its fastening system T.

FIG. 2 is a side view of the pump with the bridge with integrated pump attachments.

FIG. 3 is a side view of the pump with the bridge of the pump and an attachment that is a roller.

FIG. 4 is a side view of the pump with the bridge of the clamping system pump container and screw in the lid.

FIG. 5 is a side view of the mechanism for suction/discharge of the pump.

FIG. 6 is an explosive view of a longitudinal section of the pump components.

FIG. 7 is a longitudinal sectional view of a mechanism of suction/discharge.

FIG. 8 is a longitudinal sectional view of a pump Bridge.

FIG. 8A is a perspective view of one embodiment of the bridge of the pump.

FIG. 9 is a front view of the valve body.

FIG. 10 is a front view of the part valve body named without union nut.

FIG. 11 is a perspective view of the piece called internal container.

FIG. 12 is a frontal view of the piece called internal container.

FIG. 13 is an explosive view of the parts that make up the fastening system with container hook.

FIG. 14 is a perspective view of an embodiment of the clamping system with setscrew container below the container lid.

FIG. 15 is a top view of the set screw of the fastening system of the container with lid.

FIG. 16 is a side view of the set screw inserted into the oppressive nut with tapered end.

FIG. 17 is an explosive view of the two pieces that make up the set screw.

FIG. 18 is a view of a longitudinal section of FIG. 17.

FIG. 19 is a perspective view of an embodiment of tube oppressive.

FIG. 20 is a view of a longitudinal section of FIG. 19.

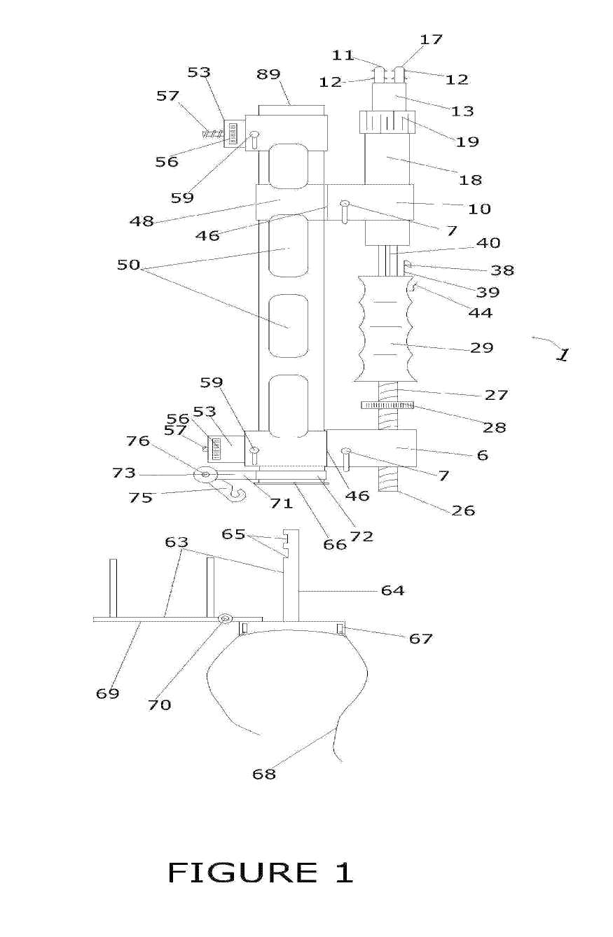

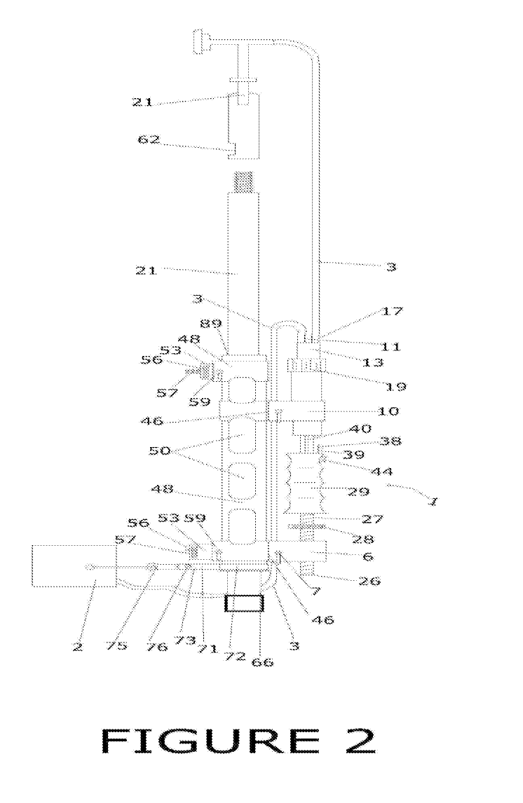

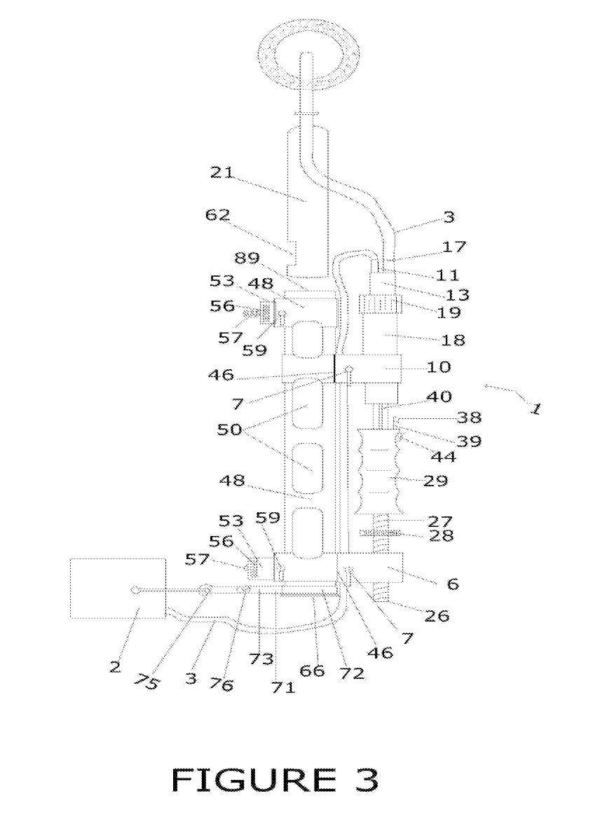

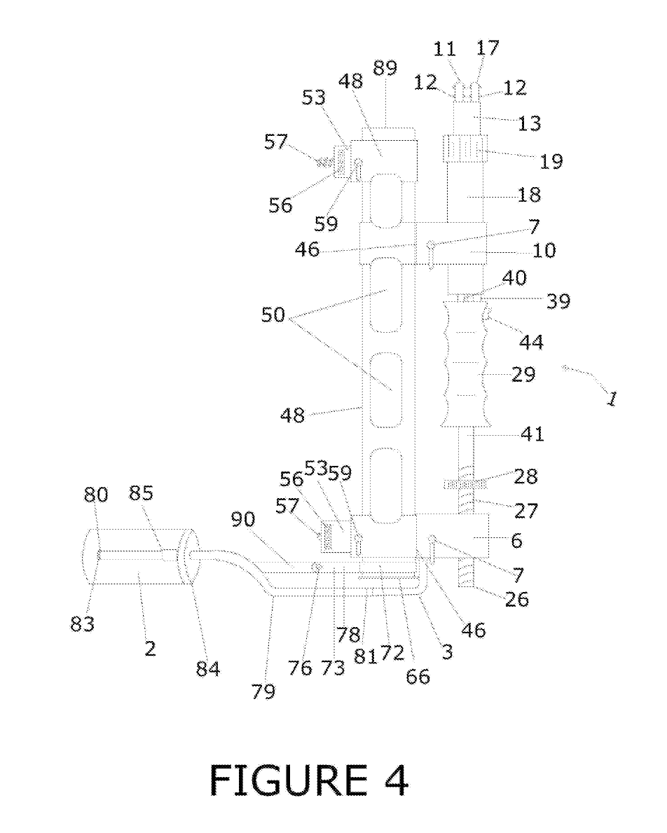

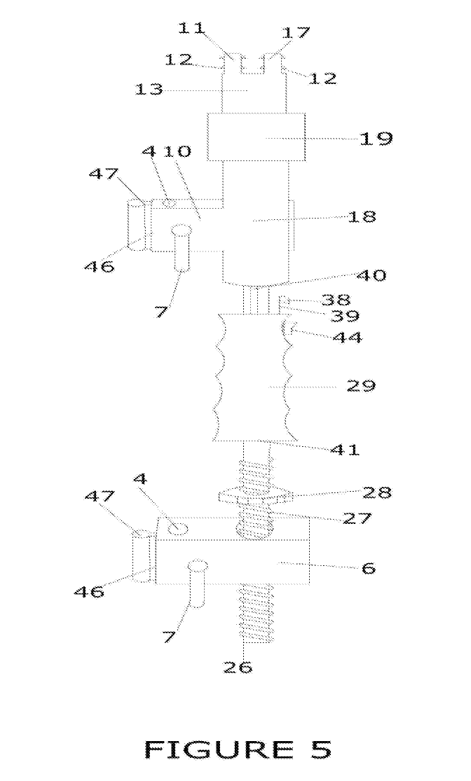

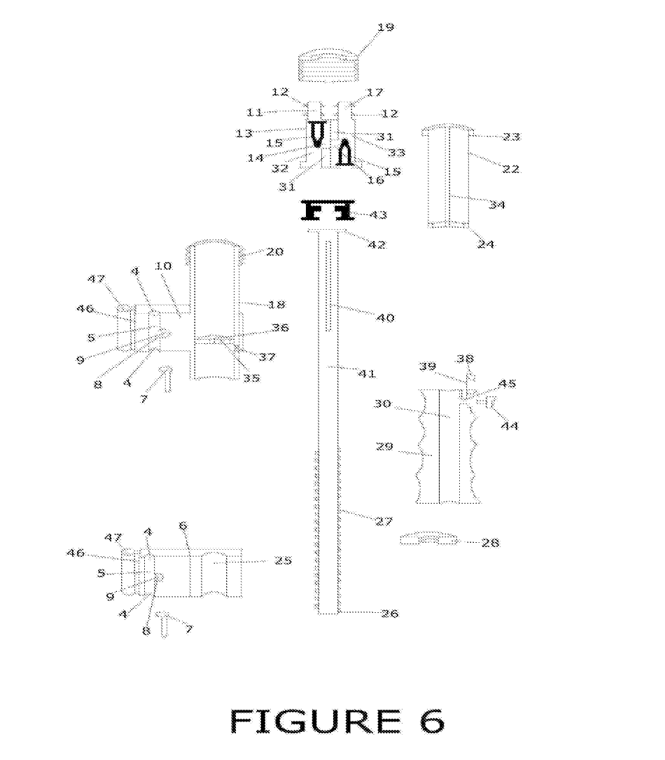

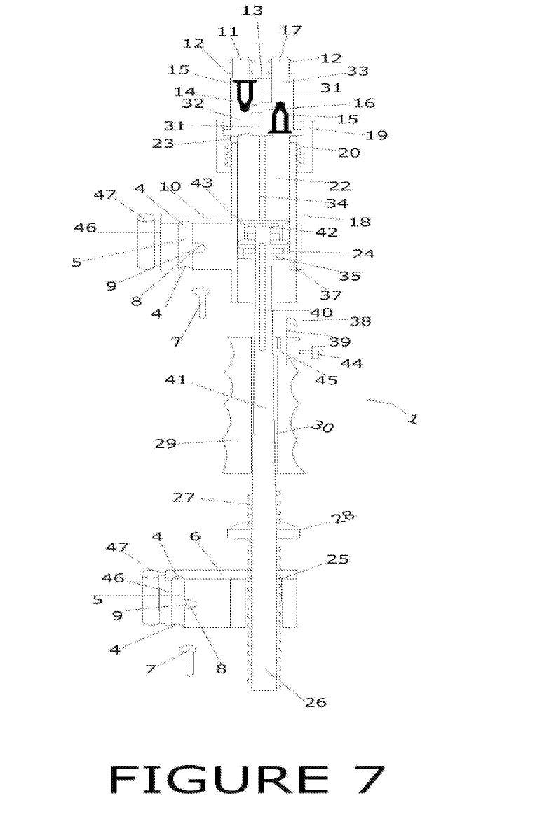

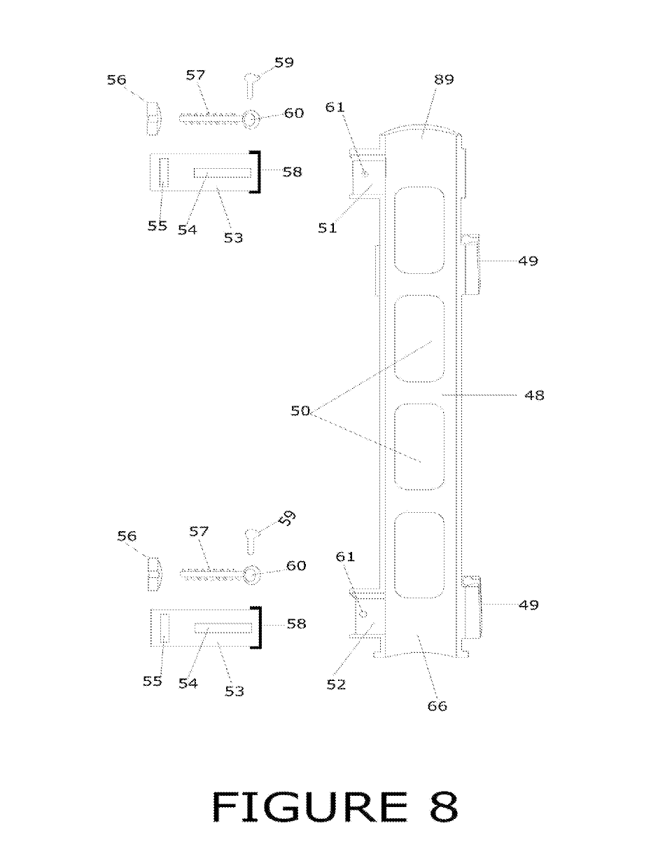

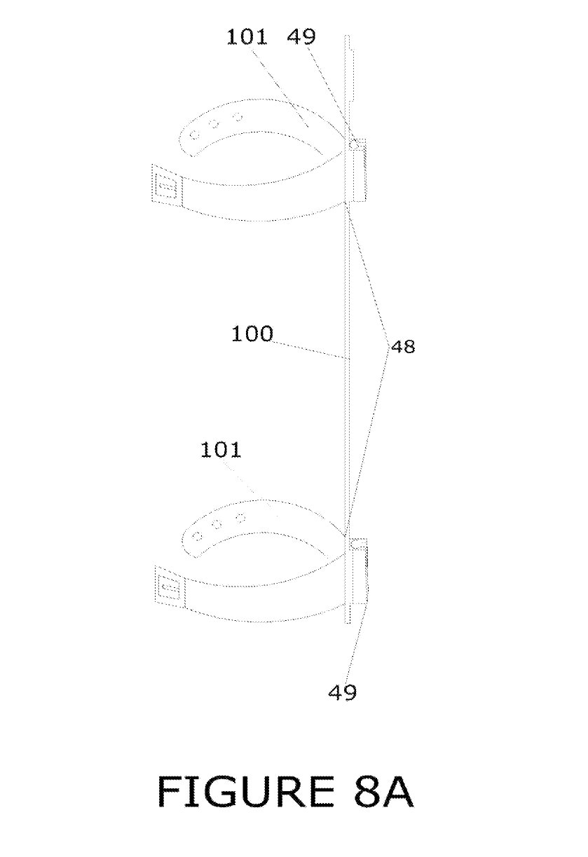

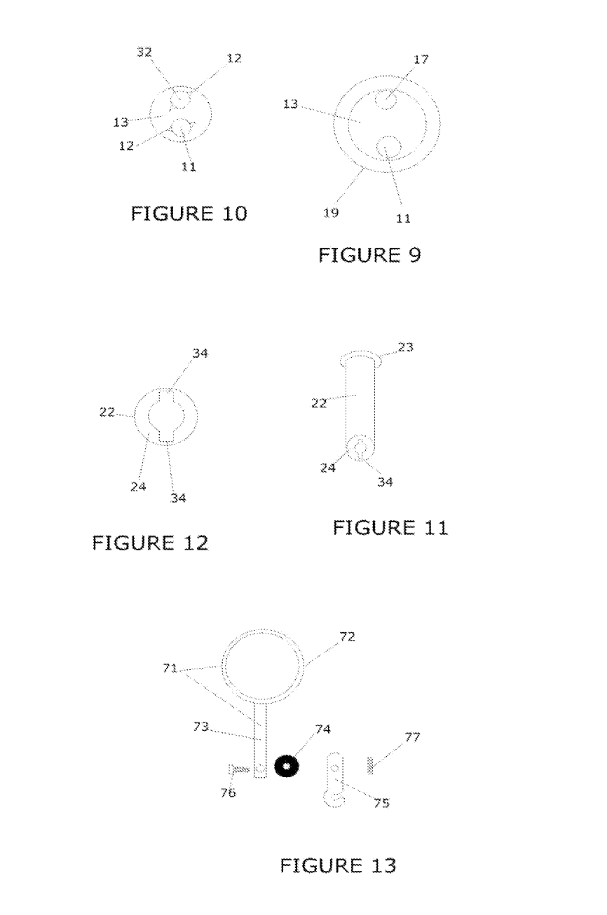

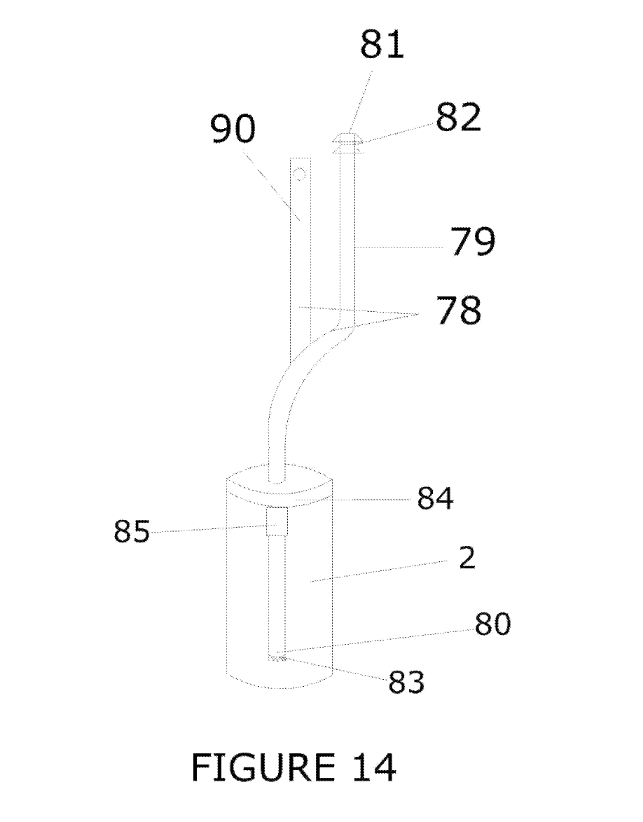

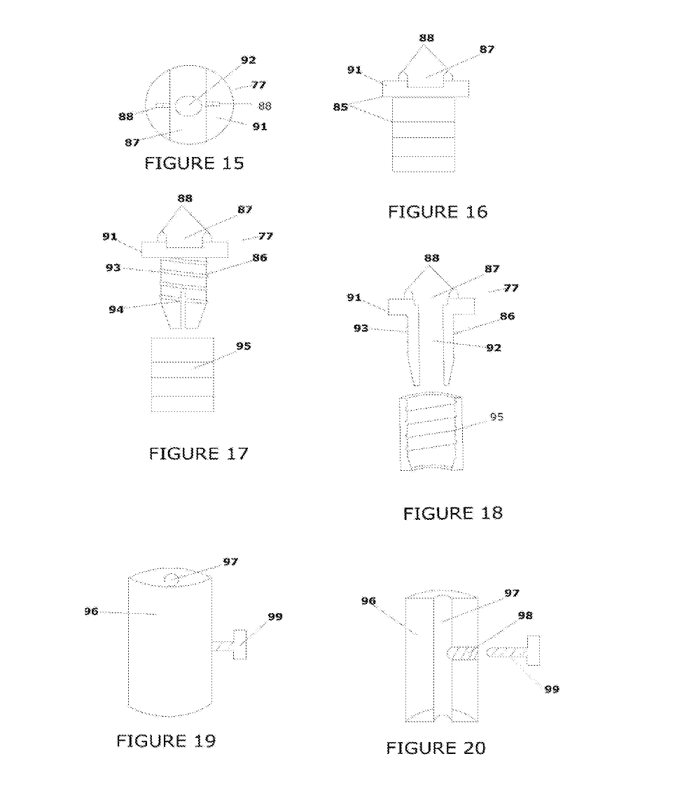

### DISCLOSURE OF THE INVENTION

The characteristic details of the present invention that include means for delivering liquids or gases efficiently, are described below and based on the figures mentioned by way of example, so that they should not be regarded as limiting.

As seen in the figures, the construction of the pump of the present invention comprises mainly a mechanism suction/discharge (1) for delivering liquids or gases; a container (2) manufactured in one piece which is intended to contain liquid or product should be projected through suction/discharge to a hose (3) that carries the product of any material, said hose (3) is chemically resistant to chemicals and gases corrosion. The hose (3) is inserted through a hole (4) having a lower passed duct (5) located in the bottom of a primary fastening bracket (6) of the mechanism body (1), same hose (3) is pressed inwardly by a pressure cam (7); said cam is positioned within a bore (8) with upper passed duct (9), which is a few millimeters higher than the passed duct (5), but these two ducts (5 and 9) are between crossing internally and serve as guide the hose (3) to be pressed by the cam (7) and thus push the flow of material transported internally by the hose (3); that mechanism (1) has a secondary clamp bracket (10) in its lower part, where the hose (3) will pass to be connected to an entry nozzle (11) of liquids or gases, this nozzle (11) is a tube in its outer part has some small subjection protrusions (12) already known it by one skilled in the art, that serve as gripper pressure of the hose (3); said nozzle (11) is integrated in one piece, preferably circular called valve body (13) having two cylindrical internal cavities, one inlet (14) and an output (16), which also include two small protrusions (31) serving to thin output cavities (32 and 33), thereby allowing for which when inserted, at least, a pair of inverted duckbill valves, metallic pellet, membrane or any other type of valve (15), they have only a limit inward movement, and the flow of liquids or gases, exerts a higher internal pressure, being vented to the outlet nozzle (17), which will engage another length of hose (3) that serve to mate with any other mechanism (21) such as a brush, roller, spray liquid, nebulizer or a pivot for inflating tires, balls, balloons, etc.

The valve body (13) is coupled to an elongated piece of tubular shape and internally passed called inner container (22) that is where the liquid or gas are deposited to be ejected from the mechanism of suction/discharge (1), said inner container (22) has at its left end a circular salient (23) on the outside and the other right end has a circular salient (24), plus two internal channels (34) that run throughout the body internal of the inner container (22). Subsequently it will be inserted into a pumping chamber (18), which is a cylindrical body and in its internal part is smooth and slightly larger than the inner container (22). The pumping chamber (18) has a circular salient (35) with two slots (36) of the same size internal channels (34) of the inner container (22), said circular salient (35) is more located at the right of cylindrical body of the pumping chamber (18) which will first function limit and coupling the inner container (22) by its right end, and as a second function is limiting the sliding of a piston (26); at the top inside of the cylindrical body of the pumping chamber (18) there is a small cavity (37), which serve to accommodate a metal tip or any material (38) of the insurance fastening's lamella (39) of an ergonomic handle (29); on the left side of the pumping chamber (18), in its body's outer part has a threaded section (20), wherein the valve body (13) will be coupled, both parts will be subjected to pressure by a union nut (19) in order to join these two parts and liquid or gas no exhaust; in the lower right part of the pumping chamber (18) projects a section which forms the secondary bracket (10) which has a hole (4, 8), ducts (5 and 9), and a cam (7), all identical to those described in the primary bracket (6).

The piston (26) of the body of the mechanism (1) is made of a single cylindrical piece or can change its shape or design, if necessary, is made of resistant material, which may be plastic or any other material. Said piston (26) has at its right end a threaded region (27), in the central part (41) is smooth, and on the left side has two projections or guides (40) on each side of the piston (26), in the beginning of the left side has a circular part (42) coupled to the piston (26) of the same material, to which is coupled a rubber gasket (43) made of a material resistant to friction and abrasion of the liquids or gases. To install the piston (26) to the body mechanism (1), first threaded end (27) enter the pumping chamber (18), which was previously inserted the inner container (22), to enter and pass through holes (34 and 36), respectively, leaves the body of the piston (26), then passed through a hole with passed duct (30) located on the ergonomic handle (29) and subsequently will be coupled a metering screw (28), which depending on its position, allows that the piston (26), when driven scroll or slide a certain distance, which is directly proportional to the amount of product entering the mechanism; then pass through another hole with threaded pipe (25) located in the top of the primary support (6), the piston (26) is inserted into the threaded passage (25) being firmly and aligned within the pumping chamber (18) where the circular piece (42), together with the gasket (43), will encounter with the inner part of the inner container (22).

The ergonomic handle (29) will have a subject button (44), which will be at the top of the handle (29), inserted into a hole (45), the subject button (44) will have a system security is a metal tip or any material (38) and a slide fastener insurance (39), this security system in the handle (29) serves for the time of pumping and if you want the handle (29) is secured to the body of the pumping chamber (18), the metal tip (38) is housed in the recess (37) and thus the handle (29) has no movement, in addition to the guides (40) gives firmly and not allow the handle to move or rotate on its axis.

The supports (6) and (10), its role is to support the suction/discharge mechanism (1) by firmness in the pumping chamber (18) together with the piston (26), to be located in the extreme, totally eliminate any bending force on the seal (43), the mechanism (1) when loaded and manipulated the mechanism manually, using the ergonomic handle (29). Said supports (6 and 10) in the bottom (46) have a subject system similar to the male and female slide (47) or any other that can engage it, with this subject system will engage it a bridge (48), which in this description, is a passed tube, tubular in shape, with a light and strong design, has an inlet (89) and an outlet (66), a fastener (49) at its upper end, according to subject at fastening (47) and thereby to unite the supports (6, 10) of the mechanism body (1); said bridge (48) has the same along at least two parallel holes (50), and its only function is to reduce the body weight of the bridge (48), its location is strategic in order not to detract stiffness and strength, presents in its lower left and right ends, a fastener cavity (51, 52) in square shape, and each an oppressive piston (53) slides. Within the oppressive piston (53) are a fastener cavity (54) and a slot (55) for an oppressing nut (56). In fastener cavity (54) is housed an oppressive screw (57) which is fastened with the oppressing nut (56). The oppressor piston (53) is made of resistant material, can be plastic or PVC, and at its upper end (58) of a non-skid material; said oppressing piston (53) further has an additional clamping mean, which is an oppressive cam (59) of oppressing piston (53), which holds the oppressive piston (53) through an orifice (60), presenting the oppressive screw (57), when the oppressor piston (53) slides by the fastener cavities (51 and 52) and the oppressive cam of piston (59) engages the set screw (57) through hole (60) set screw (57); oppressive cam piston (59) is inserted into a cavity (61) of the fastener cavities (51 and 52) and turning this oppressive cam (59), this action set screw (57) rises and consequently screw up the oppressor piston (53), said oppressor piston subjects and press some attachments or items (21), these attachments, such as a pole, brush, roller handle extension, etc., at its end lower back have another squared fastener cavity (62) and for her the oppressive piston (53) slides, and in this oppressive piston, beside hold, its function is to retain and support a fastening mechanism (63) of the pump, which comprises: a T-shaped piece (64) having in its front part, at least two rectangular apertures (65), which have the function to be inserted in the outlet orifice (66) of the bridge (48) of the mechanism (1), where the fastener cavity (52), the oppressive piston (53) is inserted to perform the holding function; the T-shaped piece (64) has at its rear ends two holes (67), which house some securing means such as strap (68), whose function is to fasten the pump at user's body. The clamping mechanism (63) also has a further component which is a support (69) of the container (2) of the product, which, in the part that binds to the T-shaped piece (64); this likewise has a fastener (70). The support (69) of the product container, its only function is to allow adjusting the container (2) some degree angle to avoid spilling the product. This type of clamping mechanism is important for the operation of the pump of the present invention under which to develop certain types of activities as agricultural areas fumigation.

Another mode for attaching the container (2), of the pump of the present invention is that said container (2) is anchored in a fastening means (71) in the rear of the bridge (48), said means clamping (71) has a body which is divided into a circular attachment clamp (72), a right clamp body orifice (73), a circular gasket (74), a piece in the form of hook hole clamp including (75), a screw (76) and a nut (77). To shape the fastener (71) of the container (2), joined the straight body with the hole (73), with gasket (74), to the shaped part of the hook (75) through its orifice and insert the screw (76), which will hold it and will press with a nut (77), thereby forming the holding means with the clamp and hook (71), which join said parts provides such resistance to container (2), to effect prevent that this have movement. This embodiment of the pump of the present invention is for use when the weight of the container (2), is lighter and allows the user to work more freely.

Another modality for fasten the container (2), of the pump of the present invention is that the container is anchored in a fastening means (78) located in the rear of the bridge (48), said fastener (78) is very similar to the mode above it, since the top of the entire part of the body of the circular clamp fastening (72) with a straight grip body orifice (73) is used, the screw (76) and nut (77), and gasket (74); since this is coupled to the clamping means (78) which is formed of a rigid body and prolonged with a orifice on the upper end (90) which is coupled at its lower part to a curved semi-rigid metal tube (79), which has in its upper part a nozzle (81) with fastening means (82) where the hose (3) is coupled, and on its other lower end has a suction nozzle shaped punch (80), which at its tip has pointed teeth (83) that serve to perforate any material, preferably plastic or thin metal; the tube (79) through its punch tip (80) pierces any lid (84) of any container reuse, either a pot, a bottle, jug, etc. When the lid (84) plastic or metallic is pierced, a hole the same size as the metal tube (79) is formed, consequently the said tube (79) is inserted, the lid (84) is raised by the pipe (79), and then will engage a fastener called set screw (85) which is formed of a screw (86) which in its upper part has a cross channel (87) that runs through its central part, two small blades (88) arranged to each other, one on each end of the top of the screw (86) that serve to make holes in the plastic covers; an outgoing (91) surrounding the entire periphery of the screw, which will guide blades (88) when turning and cutting any plastic; a passed duct (92) passing through the center of the screw (86); a threaded region (93) and a millimeter passed channel (94) through the tip of the screw (86), later will couple it an oppressive nut with conical end (95), which get inside the screw (86) together with the metal tube (79); when placed at the desired distance, and will be tightened firmly beneath the lid (84) of the container (2) being suspended in the container. This embodiment of the pump of the present invention is to be used when the weight of the container is lightweight and recycled second hand as soda bottles, cans, jugs, containers etc., are used.

Another embodiment of the fastener of set screw is that is an oppressor tube (96), which has a passed duct with inlet and outlet (97), which runs through the center of the oppressor tube, and the side has another internally threaded duct not passed with inlet (98), which will insert a screw (99) that serve to tighten the tube (79), plus it serves as an anchor to the top, because when placing the cover (84) with the rigid tube (79) and the oppressor tube (96) beneath the lid, the container is closed, with the liquid, where it is suspended. This embodiment of the pump of the present invention is to be used when the weight of the container (2) is lighter and recycled second hand containers are used.

One embodiment of the bridge (48) of the pump, is that the composition is rigid to keep giving the necessary firmness in the first support (6) and second support (10), and having a metal line (100) or any other material; on its upper surface has fastening means (49) according to the needs of the mechanism body (1), which will engage in the bottom (46) of the primary supports (6) and secondary (10), by its clamping means (47); said bridge will have other fastening means may be any required form regardless of shape or design, but it can be adapted to the needs of the user, in this case is a pair of straps (101) that are engaged and secured to the body the metal line (100).

1. A mechanism suction/discharge for delivering liquids or gases, comprising:
i) a handle located at the top of a pump suction/discharge, where clamping means and injection pump are located;
ii) at least one piston located in the body and inside the pump with at least a dispenser on the rear of the piston;
iii) a valve body having at least two chambers, two valves, one inlet and one outlet, inlet and outlet nozzles;
iv) an inner container of the pump is located inside the pump body;
v) a piece that has a pumping chamber, at least two supports, primary and secondary, and holding means;
vi) a bridge pump with at least two fastening means with oppressive cam of duct and piston;
vii) attachments or items pump; and
viii) mechanisms for securing the container.

2. The mechanism of the previous claim wherein said mechanism is a suction/expulsion pump of fluids or gases of manual action.

3. The mechanism of claim 1, characterized by an ergonomic handle which holds the piston pump, and further comprising a fastener that holds or releases the piston of the pump body.

4. The mechanism of claim 3, characterized by comprising a fastening button, which is on top of the ergonomic handle, inserted in a hole in the handle body, the fastening stud has a security system which includes: a metal tip or any material, a metal foil secure fastening, this safety system is that the time of pumping and if desired the handle is secured to the body of the pumping chamber, the tip metal is housed in the cavity and thus the handle does not move and if it wants to move the handle which pushes the button and bows to the foil and this releases the tip of the cavity is tightened.

5. The mechanism of claim 1, comprising a piston located in the pump body, which is made of a single cylindrical part or may vary in shape or design, is of a strong material, which can be plastic or any other material; which is at the right end threaded area in central zone is smooth, and in his left two projections or guides for each side of the piston, which help the ergonomic handle to keep it from rotating on its axis part; the left side of the piston body, having a circular part coupled the same material, which is coupled to a rubber gasket made of abrasion-resistant or abrasion of liquids or gases material.

6. The mechanism of claim 5, comprising a dispenser nut and distance meter of the handle that fits onto the threaded section of the piston, which limits the piston stroke and consequently the amount of liquid or gas to be injected into the shirt in each suction pump.

7. The mechanism of claim 1, wherein the valve body which is part of the pump casing suction/discharge, comprising: a nut of a preferably circular shaped piece body it is called valves, which has on its outside at least two nozzles in tubular form, one input and another output of liquids or gases, on its outer part has small protrusions inserted clamping pressure hose conveyor liquids or gases, the fixed not to move or exit; has two cylindrical internal cavities, one input and another output, which have integrated two slightly thicker small protrusions or walls that serve to thin the outputs of the cavities, allowing with this insert at least two valves, which shall a limit of inward movement, at least two outlets in the rear of the part through which the liquids or gases flow and enter the pump sleeve, and to be expelled by the piston exerts a greater internal pressure toward the outlet nozzle, which is coupled another length of hose.

8. The mechanism of claim 7, wherein the valves are diaphragm type or duckbill or ball or any form or type.

9. The mechanism of claim 1, wherein the inner container is the pump suction/discharge, is an elongated piece, tubular and internally passed, at the left end has a circular external body part of the protrusion container and other extreme right inside of the container body has a circular has two internal channels that run throughout the body through which pass the piston guides a ledge.

10. The mechanism of claim 9, wherein the inner container of the pump is coupled internally in the pumping chamber into abutment with circular (35) projection, subsequently the piston is inserted and its left side is joined by valve body and is held by the nut.

11. The mechanism of claim 1, wherein the pump body is divided into: pumping chamber, the piston primary backing, secondary backing pumping cavity, holding means for hose, clamping means for the bridge pump.

12. The mechanism of claim 11, wherein the pumping chamber is cylindrical in shape, the inside is smooth and slightly larger than the body of the shirt, which is housed therein; has an internal circular projection with two slots of the same size as the channels of the inner container, said inner circular protrusion is more loaded right barrel cavity pump, its function is limited and coupled to the internal container, its right end, and limit the piston stroke in the upper inner cylindrical body cavity pump is a small cavity that serves to accommodate the metal tip of the blade clamping insurance ergonomic handle; on the left side of the pumping chamber in its outer body part has a threaded section in which the valve body will be subjected to pressure that is engaged by the nut in order to join these two parts and liquid or gas from escaping; in the lower right part of the pumping chamber, a united body section which forms the secondary fastening bracket projected.

13. The mechanism of claim 12, wherein the body of the pumping chamber secondary clamp a supporting section, which has holes (4) and (8), pipelines (5) and (9) projects, and cam (7) which serves for fastening the tube that carries the product to the pump tank; at the bottom has a set of female and male type slide fastener or otherwise be coupled to it; and this restraint is provided for coupling pump bridge.

14. The mechanism of claims 11 and 13 wherein the primary fastening support piston pump body, at its top, has a pierced hole where the threaded region the piston is introduced, which gives firmness the pump body and the piston and at the bottom it is inserted a hose of liquids or gases transported container, said hose is inserted through a hole having a pierced conduit is at the bottom, same hose is pressed by a cam internally pressure; said cam is placed into a hole with superior pierced duct, which is a few millimeters higher than lower pierced line, but these two conduits between cross internally and serve to guide the hose to be pressed by the cam and so pressing the flow of material transported by said hose internally; same system has the secondary clamp support.

15. The system of claims 11, 13 and 14, wherein the primary and secondary supports, their function is to support the body of the pump by firmly into the pump cavity, which in conjunction with the piston, being located at the ends totally eliminate any bending force on the pump seal, when loaded and manipulated by hand pump ergonomic handle.

16. The mechanism of claims 1, 13 and 14 characterized in that the means of female and male primary fastening brackets and secondary clamp bridge joins pump, a pierced tube, with two holes one input and an output, is tubular in shape, with a light and strong design, which has a fastening means according to the aforementioned subject and to attach the brackets and the pump body, said pump bridge has along the same, at least two parallel holes, and their only function is to reduce the weight of the bridge of the pump body, its location is strategic in order not to detract rigidity and strength; in its bottom left and right, has at least one holding socket into squares and each square oppressive piston within the piston is oppressive retaining a cavity, and a slot for sliding nut oppressive. In holding socket is housed inside an oppressor screw which is fastened with the oppressive nut; wherein said piston oppressor has an additional anchoring means, an oppressive cam piston, which holds the oppressor piston bore dare presenting the set screw, when the oppressor piston slides by holding socket and oppressive cam piston engages with the set screw through the hole of the setscrew, oppressive cam piston is inserted into the cavity of the cam and round the oppressive cam piston, this action the set screw rises and consequently screw up the oppressor piston, said piston and press oppressor subject to additions or articles.

17. The mechanism of claim 16 wherein the cavities holding the clamping piston is technically the role resistant material comprising at least a non-slip material on its upper end slides.

18. The mechanism of claims 1 and 17, characterized in that the attachments or articles, to be used are one pole and handle extension of roller, brush, etc., which at its lower end rear cavity presents another fastening square and for her oppressor piston, which in addition to holding its function is to retain and support the mechanism to be inserted into the bridge of the pump body slides.

19. The mechanism of claim 1, wherein the clamping mechanism of the pump comprises: a T-shaped piece, which has at its front part, at least two square holes, which have the function, that when inserted in the outlet of the pump bridge, where the cavity of the clamping piston is subject, is inserted to perform the holding function; the T-shaped piece, at their rear ends have two bores, which accommodate the clamping strap means, same type as its function is to secure the device to the user's body; the clamping mechanism of the pump also presents another component which is the support of the product tank, which in the part that binds to the T-shaped part has a holding means, the reservoir holder of the product, only function is to adjust the degree of deposition angle to avoid spilling the product.

20. The mechanism of claim 1, wherein a mode for holding the container is anchored in a holding means in the rear of the bridge of the pump, is that the fastener has a body that is divided into: clamping a circular clamp, a right clamp body orifice, a circular gasket, a piece of hook-shaped fastener-hole, a screw and a nut.

21. The mechanism of claim 20, wherein shaping the container restraint system, joins the clamping body with straight hole with packing and hook-shaped part, where the hole is to proceed insert a screw, which is fastened and tightened with a nut, thereby forming the fastening system and the hook clamp.

22. The mechanism of claim 1, wherein another embodiment for attaching the container is anchored in a holding means in the rear of the bridge of the pump, said fastener is similar to the method above and will the top of the entire part of the body of the clamp restraining circular, straight grip body orifice, screw, nut and gasket is used, it is subsequently engages a rigid body and prolonged hole at its upper end, the which is coupled at its bottom to a pierced metal and semi-curved rigid tube having in its upper part with a nozzle attachment means and at its other lower end has a suction nozzle shaped punch, which in its tip several pointed projections will project and was subsequently engages a fastener called setscrew, which is divided into: the screw in its upper part has a transverse channel which runs along its central part, two small blades disposed between itself a at each end of the top of the screw, a ledge, which encircles the entire periphery of the screw, which serves as a guide for the blades; a pierced passageway through the center of the screw, a threaded region and pierced channel millimeter across the tip of the screw; subsequently an oppressive nut with conical end is coupled, which in its interior receive the screw with the rigid metallic conduit to be placed at the desired distance, it was pressed and remain solid under the lid container, being suspended in the body of pump.

23. The device of claim 22, wherein another embodiment for attaching the container is anchored in a rigid metal tube holding means is formed of: an oppressive tube, which has a passed duct with entry and exit, that runs through the central part of the oppressor tube and the other side has not passed internally threaded pipe with inlet, which is inserted a screw fastener that serves to tighten the rigid tube, plus it serves as an anchor to the lid, as when the lid together with the rigid pipe and the clamping tube under the lid, the container is closed with a liquid, being suspended in the pump body.

24. The device of claim 17, wherein the bridge further embodiment of the pump, is that the composition is rigid to keep giving the necessary firmness in the primary and secondary supports and line having a metal or other materials, in upper surface has fastening means which engage in the bottom of the primary and secondary fastening means for its supports; the bridge has other fastening means may be any other, regardless of their shape or design but can be adapted to user needs, here is a pair of straps that are coupled and subject to the body of the metal line.
